(19) United States
(12) Patent Application Publication
(10) Pub. No.: US 2013/0113430 A1
(43) Pub. Date: May 9, 2013

(54) BATTERY PACK AND METHOD OF CONTROLLING THE SAME

(71) Applicant: Samsung SDI Co., Ltd., Yongin-si (KR)

(72) Inventor: Tae-Jin Kim, Yongin-si (KR)

(73) Assignee: Samsung SDI Co., Ltd., Yongin-si (KR)

(21) Appl. No.: 13/665,434

(22) Filed: Oct. 31, 2012

(30) Foreign Application Priority Data
Nov. 7, 2011 (KR) 10-2011-0114906

(51) Int. Cl. H02J 7/00

(52) U.S. Cl. 320/134; 320/136

(57) ABSTRACT

A battery pack and a method of controlling the same are disclosed. According to one aspect, when a voltage of a battery pack or a terminal voltage is greater than a predetermined voltage when the battery pack returns from an over-discharge state, an input voltage switch of a direct current (DC/DC) converter is switched on, whereby power is stably supplied to a control unit of the battery pack. When the voltage of the battery pack is less than a predetermined voltage during discharging, a leakage of current to the DC/DC converter from a battery cell is reduced or avoided and consumption of power of the battery cell is reduced or avoided.

### CROSS-REFERENCE TO RELATED APPLICATIONS

This application claims the benefit of Korean Patent Application No. 10-2011-0114906, filed on Nov. 7, 2011, in the Korean Intellectual Property Office, the disclosure of which is incorporated herein in its entirety by reference.

### BACKGROUND

1. Field

The technical field relates to a battery pack and a method of controlling the same.

2. Description of the Related Technology

In general, rechargeable batteries are actively researched due to the development of mobile electronic appliances such as cellular phones, laptop computers, camcorders, personal digital assistants (PDAs), and the like. Examples of rechargeable batteries include nickel-cadmium batteries, lead storage batteries, nickel metal hydride (NiMH) batteries, lithium ion batteries, lithium polymer batteries, metal lithium batteries, and air zinc storage batteries. A rechargeable battery is combined with a circuit to form a battery pack and is charged or discharged via an external terminal of the battery pack.

Generally, a battery pack includes a number of battery cells and a peripheral circuit or protection circuit including a charge/discharge circuit. The peripheral circuit may be formed on a printed circuit board (PCB) and is combined with the battery cell. When an external power source is connected to the battery pack via an external terminal, the battery cell is charged by the external power source via the external terminal and the charge/discharge circuit. When a load is connected to the external terminal, the battery cell supplies power to the load via the charge/discharge circuit and the external terminal. In this regard, an internal power supply of the battery cell or an external power supply may be used as a power supply of the charge/discharge circuit or the protection circuit.

### SUMMARY OF CERTAIN INVENTIVE ASPECTS

According to one aspect, a battery pack is disclosed. The battery pack includes at least one battery cell, an over-discharging switch connected between the at least one battery cell and a terminal of the battery pack, a control unit configured to control the over-discharging switch, a direct current (DC/DC) converter configured to supply power received from the battery cell to the control unit, a voltage sensing unit configured to sense a voltage of the battery pack, and an input power switch configured to switch the power input to the DC/DC converter based on the sensed voltage.

According to another aspect, a battery pack is disclosed including at least one battery cell, an over-discharging switch configured to block over-discharging of the battery cell, a control unit configured to control the over-discharging switch, a DC/DC converter configured to supply power from the battery cell to the control unit, a first voltage sensing unit configured to sense a voltage of the battery pack, and an input power switch configured to switch the power input to the DC/DC converter according to the sensed voltage.

According to another aspect, a method of controlling a battery pack comprising at least one battery cell is disclosed. The method includes switching off an over-discharging switch, sensing a voltage of the battery pack, switching on an input power switch of a DC/DC converter if the voltage is greater than a first threshold value, and supplying power to the control unit through the DC/DC converter.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings of which:

FIG. 1 is a circuit diagram of a conventional battery pack;

FIG. 2 is a circuit diagram of a battery pack according to some embodiments;

FIG. 3 is a circuit diagram of a battery pack according to some embodiments;

FIG. 4 is a flowchart of a method of controlling a battery pack according to some embodiments; and

FIG. 5 is a flowchart of a method of controlling a battery pack according to some embodiments.

### DETAILED DESCRIPTION OF CERTAIN INVENTIVE EMBODIMENTS

Hereinafter, various aspects and features will be described in detail with reference to the accompanying drawings. In the description, only the detailed descriptions needed to understand operations according to some embodiments will be provided and other descriptions may be omitted so as not to hinder the understanding of the embodiments. [0016]

Further, the meaning of the terms used in the specification including the appended claims should not be construed as being confined to a common or dictionary meaning, but should be construed as concepts not departing from the spirit and scope of the described embodiments in order to describe the invention in the most appropriate way.

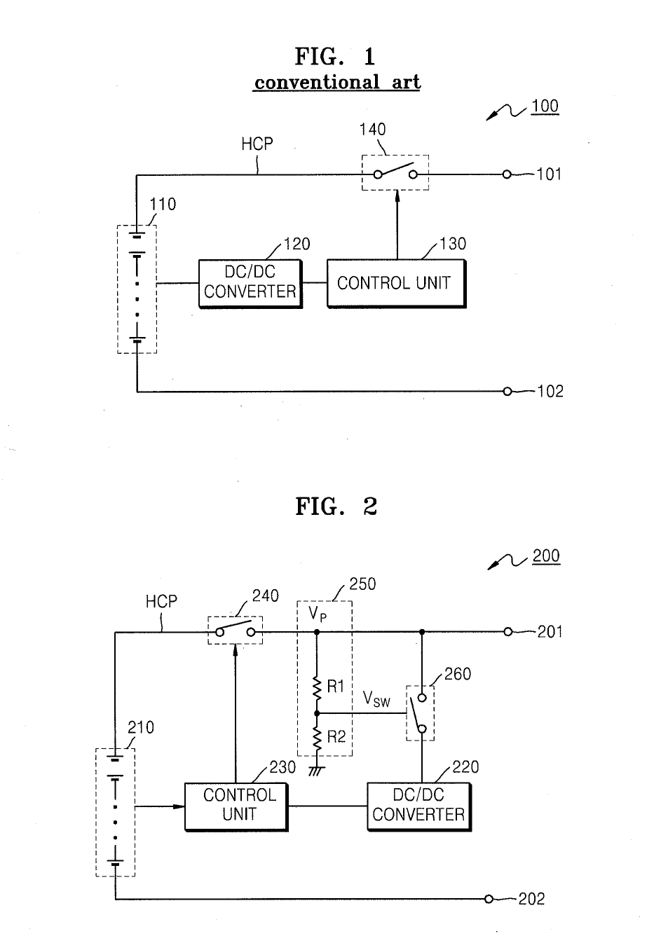

FIG. 1 is a circuit diagram of a conventional battery pack 100.

Referring to FIG. 1, the battery pack 100 includes a rechargeable battery cell 110 and a direct current (DC-DC) converter 120 that is configured to convert a power received from the battery cell 110 and supply the converted power to a control unit 130. Charging of the battery cell 110 by a charger (not shown) and discharging of the battery cell 110 are performed via charge and discharge terminals 101 and 102 of the battery pack 100.

As shown in FIG. 1, the battery pack 100 includes the battery cell 110 with the charge and discharge terminals 101 and 102 connected in parallel to the battery cell 110. The battery pack 100 also includes an over-discharging switch 140 that is connected in series to a high current path (HCP) between the battery cell 110 and the charge and discharge terminals 101 and 102, and a control unit 130 that controls the over-discharging switch 140.

The DC/DC converter 120 converts the power received from the battery cell 110 into DC power at a power level for driving the control unit 130. For example, if the control unit 130 and/or other components of a device operate at 5 V DC, the DC/DC converter 120 converts a voltage output level received from the battery cell 110, for example, 50 V, into 5 V to be input to the control unit 130. Although only a down converter operation has been described, an up converter may be also used considering a capacity of the battery cell 110 and a voltage level for driving the control unit 130. Therefore, a converter is not limited to the DC/DC converter 120. The battery pack 100 may further include a battery cell circuit, e.g., an overcharging switch and an analog front end (AFE) integrated circuit (IC) (not shown). In addition, the battery pack 100 may further include a fuse (not shown) that is positioned on the HCP. The fuse may be configured to block a charging and discharging path according to a control signal of an AFE IC and a self-protecting control unit configured to disable the fuse (e.g., creating an open circuit in the charging and discharging path).

If the control unit 130 determines that the battery cell 110 is over-discharged, the control unit 130 may be configured to turn off the over-discharging switch 140 or disable the fuse (not shown), thereby blocking the over-discharging of the battery cell 110.

The battery pack 100 having the structure described above is connected to an external system through the charge and discharge terminals 101 and 102 and performs charging or discharging. The HCP between the charge and discharge terminals 101 and 102 and the battery cell 110 is used as a charge and discharge path, and a high magnitude of current flows through the HCP. The battery pack 100 may further include a system management BUS (SMBUS) for communicating with the external system.

The battery cell 110 may be a secondary battery cell that is chargeable and dischargeable. The battery cell 110 may be configured to output to the control unit 130 information regarding the battery cell 110, including, for example, information regarding a temperature of the battery cell 110, a charge voltage of the battery cell 110, and an amount of current flowing through the battery cell 110.

The over-discharging switch 140 is connected in series on the HCP between the charging terminal 101 and the battery cell 110 and blocks over-discharging of the battery pack 100. According to some embodiments, the over-discharging switch 140 may be a field effect transistor (FET).

The control unit 130 controls an overall operation of the battery pack 100 and collects information regarding performance of the battery pack 100. The control unit 130, which may be formed as part of an IC, may be a micro computer. The control unit 130 may be configured to control the over-discharging switch 140 to block the over-discharging of the battery cell 110. For example, the control unit 130 may be configured to compare a voltage of the battery cell 110 supplied from the battery cell 110 with a voltage level that is set in the control unit 130. The control unit 130 may be configured to output a switching control signal according to the comparison results, thereby controlling the over-discharging switch 140. Although direct control of the over-discharging switch 140 by the control unit 130 is described herein, the over-discharging switch 140 may be controlled through the above described AFE IC (not shown).

When the voltage of the battery cell 110 supplied to the control unit 130 is less than or equal to an over-discharge level voltage stored in the control unit 130, for example, less than or equal to 2.30 V, the control unit 130 may determine that the battery cell 110 is over-discharged and outputs the corresponding switching control signal, thereby transitioning the over-discharging switch 140 to an OFF or open circuit state. As a result, discharging from the battery cell 110 to a load connected to the charge and discharge terminals 101 and 102 is stopped.

In the battery pack 100 as described in FIG. 1, self-discharging of the battery cell 110 may occur in which, even after the control unit 130 turns off the over-discharge switch 140 when the battery cell 110 is in an over-discharge state, a current from the battery cell 110 flows to the DC/DC converter 120. As a result, the lifetime of the battery pack 100 may be reduced due to current consumption of the battery cell 110.

FIG. 2 is a circuit diagram of a battery pack 200 according to some embodiments.

Referring to FIG. 2, the battery pack 200 includes a battery cell 210, a DC/DC converter 220, a control unit 230, an over-discharge switch 240, a voltage sensing unit 250, and an input power switch 260. The components illustrated in FIG. 2 may correspond to similar components as those described above with reference to FIG. 1.

When the battery pack 200 is in an over-discharge state, a voltage Vp of the battery pack 200 is sensed so that, only when the voltage Vp is greater than a predetermined voltage, the input power switch 260 is switched on (e.g., placed in a closed circuit position). With the power switch 260 switched on, power is supplied to the control unit 230 via the DC/DC converter 220.

The voltage sensing unit 250 includes two resistors R1 and R2 configured as a voltage divider. The first resistor R1 is configured to be coupled to a terminal having a voltage level V_{P} and the second resistor R2 is configured to be coupled to the first resistor R1 and ground such that a voltage across the second resistor R2 (V_{SW} as shown in FIG. 2) is given according to Eq. 1 below:

$${V}_{SW} = \frac{{R}_{2}}{{R}_{1} + {R}_{2}} \times {V}_{P} \qquad Eq . 1$$

When a voltage across resistor R2 (e.g., V_{SW}) based on the voltage V_{P} of the battery pack 200 is greater than a predetermined voltage level, the input power switch 260 is switched on. For example, when the input power switch 260 includes a FET, the FET is turned on using a voltage applied to a gate electrode of the FET so that current flows and power is input to the DC/DC converter 220. Meanwhile, if the voltage V_{P} of the battery pack 200 is less than a predetermined voltage, the corresponding voltage V_{SW} is less than the voltage level for turning on input power switch 260 and the input power switch 260 is maintained in an off state. The values of resistors R₁ and R₂ may be set based on the parameters of the input power switch 260 such that a generated voltage V_{SW} corresponds to a voltage V_{P} such that if a voltage V_{P} is below a threshold voltage condition, the battery cell 210 would reach an over-discharged state. Therefore, even when a charge voltage of the battery cell 210 or a voltage of the battery pack 200 is applied to the battery cell 210 after the battery cell 210 is over-discharged, consumption of power of the battery pack 200 due to a leakage of current through the DC/DC converter 220 from the battery cell 210 may be reduced or avoided. If a charge voltage of the battery cell 210 or a voltage of the battery pack 200 is greater than a predetermined voltage, power is supplied to the DC/DC converter 220 so that power may be stably supplied to the control unit 230.

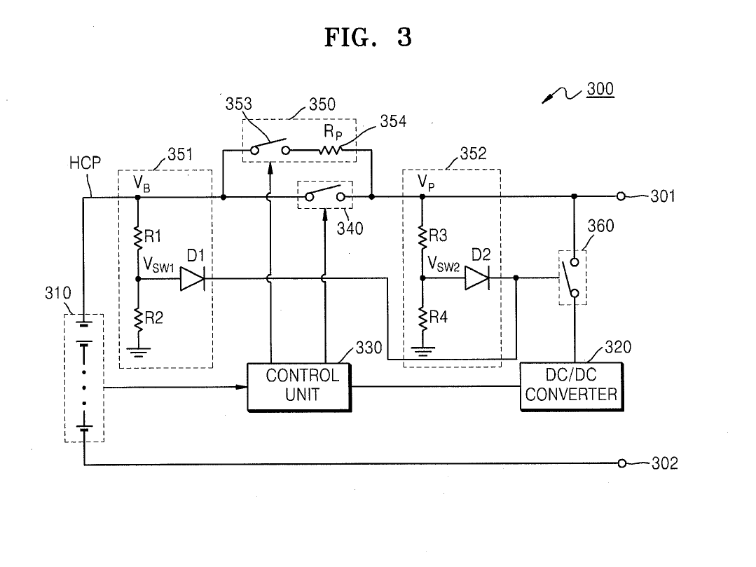

FIG. 3 is a circuit diagram of a battery pack 300 according to some embodiments. The battery pack 300 includes a battery cell 310, a DC/DC converter 320, a control unit 330, an over-discharge switch 340, and an input power switch 360. The components illustrated in FIG. 3 may correspond to similar components as those described above with reference to FIGS. 1-2 above.

As shown in FIG. 3, as compared to the battery pack 200 illustrated in FIG. 2, the battery pack 300 may further include a pre-charge circuit 350 including a pre-charge switch 353 and a pre-charge resistor 354 having a resistance Rp that are connected in series to one another and in parallel to an over-discharging switch 340. One terminal of the pre-charge circuit 350 is also connected to a first sensing unit 351 that senses a voltage V_{B} of a battery cell 310, and the other terminal of the pre-charge circuit 350 is connected to a second sensing unit 352 that senses a voltage V_{P} of the battery pack 300 corresponding to the voltage at input/output terminal 301. The first sensing unit 351 includes a voltage divider having a first resistor R1 and a second resistor R2 connected to a first diode D1. The first resistor R1 is configured to be coupled to a terminal having a voltage level V_{B} and the second resistor R2 is configured to be coupled to the first resistor R1 and ground such that a voltage across the second resistor R2 (V_{SW1} as shown in FIG. 3) is given according to Eq. 2 below:

$${V}_{SW 1} = \frac{{R}_{2}}{{R}_{1} + {R}_{2}} \times {V}_{B} \qquad Eq . 2$$

Further, the second sensing unit 352 includes a voltage divider having a third resistor R3 and a fourth resistor R4 connected to a second diode D2. The third resistor R3 is configured to be coupled to a terminal having a voltage level Vp and the fourth resistor R4 is configured to be coupled to the third resistor R3 and ground such that a voltage across the fourth resistor R2 (V_{SW2} as shown in FIG. 3) is given according to Eq. 3 below:

$${V}_{SW 2} = \frac{{R}_{4}}{{R}_{3} + {R}_{4}} \times {V}_{P} \qquad Eq . 3$$

The voltage V_{B} of the battery cell 310 sensed by the first sensing unit 351 and the voltage V_{P} of the battery pack 300 sensed by the second sensing unit 352 are applied to an input power switch 360 through the first and second diodes D1 and D2 as corresponding proportional voltage levels V_{SW1} and V_{SW2}. The first diode D1 and the second diode D2 are configured to function as diode OR gates. An output voltage (e.g., V_{SW1} or V_{SW2}) of the diode OR gates is applied to the input power switch 360, whereby a switching on or off operation of the input power switch 360 is controlled.

The over-discharging switch 340 is turned off according to switching control of a control unit 330 when the battery cell 310 is over-discharged so that a HCP is blocked. The pre-charge circuit 350 that is connected in parallel to the over-discharging switch 340 is used to prevent an inrush of current to the battery cell 310, which may occur when the over-discharging switch 340 is switched off when the battery cell 310 is over-discharged and the over-discharging switch 340 is then switched on. In addition, the pre-charge circuit 350 may include the pre-charge switch 353 and the pre-charge resistor 354 having the resistance value Rp as discussed above. The control unit 330 performs a controlling process such that shortly after the over-discharging of the battery cell 310 is blocked, the control unit 330 first switches on the pre-charge switch 350, but does not switch on the over-discharging switch 340. As a result, a current flows through the pre-charge resistor 354 for a predetermined period of time, and, after the predetermined period of time passes, the control unit 330 switches off the pre-charge switch 350 and then switches on the over-discharging switch 340, thereby returning the battery cell 310 to a normal state.

The control unit 330 switches off the over-discharging switch 340 when the battery cell 310 is over-discharged and then switches on the pre-charge switch 350 when the battery cell 310 is charged. Further, the first sensing unit 351 senses the voltage V_{B} of the battery cell 310 and the second sensing unit 352 senses the voltage Vp of the battery pack 300, and based on the sensed voltage levels, the over-discharging switch 340 is switched to an on or conductive state when the voltage V_{B} of the battery cell 310 or the voltage V_{P} of the battery pack 300 is greater than a predetermined voltage. Each of the resistors R1-R4 may be selected based on the parameters of the input power switch 360 such that the generated voltages V_{SW1} and V_{SW2} correspond respectively to voltages Vp and V_{B} such that if the voltages V_{P}and V_{B} are below a threshold voltage condition, the battery cell 310 would reach an over-discharged state

To prevent the power of the battery cell 310 from being consumed due to a leakage of current to the DC/DC converter 320 when being charged after over-discharge, the first sensing unit 351 that includes the two resistors R1 and R2 and a diode D1 senses the voltage V_{B} of the battery cell 310 in a state where the pre-charge switch 353 is switched on. Further, as discussed above, the second sensing unit 352 includes two resistors R3 and R4 and a diode D2 and senses the voltage V_{P} of the battery pack 300.

The voltages sensed by the first and second sensing units 351 and 352 are applied to the input power switch 360 through the diodes D1 and D2. Thus, if one of the voltage V_{B} of the battery cell 310 and the voltage V_{P} of the battery pack 300 is greater than a predetermined voltage, the input power switch 360 is switched on, and, on the other hand, if both the voltage V_{B} of the battery cell 310 and the voltage V_{P} of the battery pack 300 is less than a predetermined voltage, the input power switch 360 is switched off. When the over-discharging of the battery cell 310 is blocked, a pre-charge function is performed and the voltage V_{B} of the battery cell 310 and the voltage V_{P} of the battery pack 300 are sensed. If one of the two voltages V_{P} and V_{B} is greater than a predetermined voltage, the input power switch 360 of the DC/DC converter 320 is switched on, whereby a power may be stably supplied to the control unit 330 of the battery pack 300, and, on the other hand, if the voltage V_{B} of the battery cell 310 and the voltage V_{P} of the battery pack 300 are less than a predetermined voltage when the battery cell 310 is charged, the input power switch 360 is maintained switched off. When the input power switch 360 is in the off state, a leakage of current to the DC/DC converter 320 from the battery cell 310 is blocked and consumption of power of the battery pack 300 may be reduced or avoided.

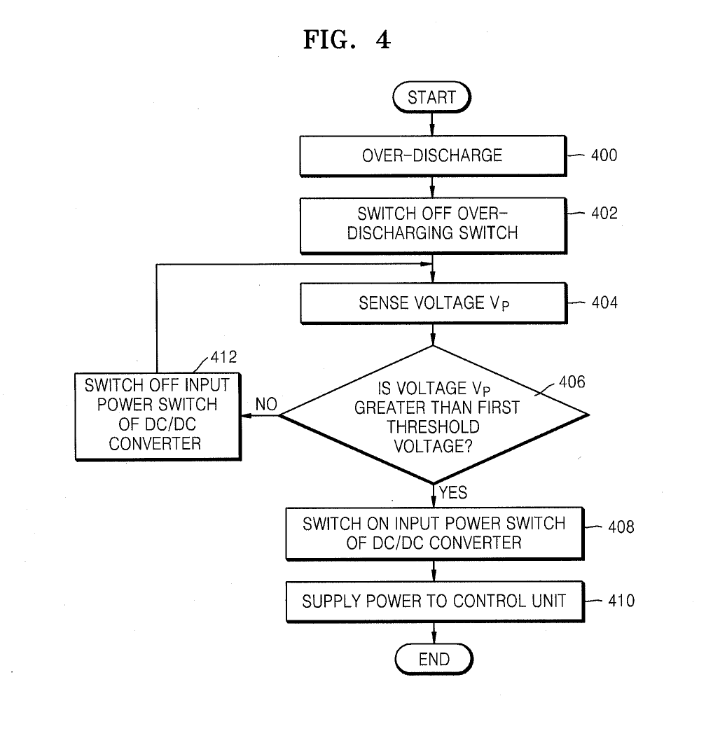

FIG. 4 is a flowchart for a method of controlling a battery pack according to some embodiments.

With reference to FIG. 4, the method includes detecting a condition at which the battery cell is in an over-discharge state as shown by block 400. When a battery cell is in an over-discharge state, an over-discharging switch is switched off and thus discharging of the battery cell is stopped as shown by block 402.

As shown by block 404, a voltage of a battery pack is sensed. When charging is performed after over-discharging, a voltage of charge and discharge terminals of the battery pack (e.g., a voltage of the battery pack or a charge voltage) slowly increases and, in some embodiments, the voltage of the battery pack or the charge voltage is sensed. At shown by decision block 406, it is determined whether the voltage of the battery pack is greater than a first threshold voltage. In some embodiments, the first threshold voltage is a predetermined value and may be determined differently according to capacity and charge voltage of a battery cell. As shown in FIG. 4, if the voltage of the battery pack is greater than the first threshold voltage, the method proceeds to block 408 and 410, and an input power switch of a DC/DC converter is switched on, whereby a power of the battery cell is supplied to a control unit through the DC/DC converter.

If the voltage of the battery pack is less than the first critical voltage, the method proceeds to block 412, and the input power switch of the DC/DC converter is maintained in a switched off state. The method then proceeds back to block 404 where the voltage V_{P} is continued to be monitored. Thus, if the voltage of the battery pack is less than the first critical voltage, it is difficult to supply the power of the battery cell to the DC/DC converter and thus the input power switch of the DC/DC converter is maintained in a switched off state, whereby an input power path to the DC/DC converter from the battery cell is blocked.

According to the above described method of controlling a battery pack, only when a voltage of the battery pack or a charge voltage is greater than a predetermined voltage when the battery pack returns from an over-discharge state, the input power switch of the DC/DC converter is switched on, whereby a power may be stably supplied to the control unit of the battery pack. On the other hand, when the voltage of the battery pack is less than a predetermined voltage during discharging, the input power switch is maintained in a switched-off state, whereby a leakage of current to the DC/DC converter from the battery cell may be prevented and consumption of power of the battery cell may be prevented.

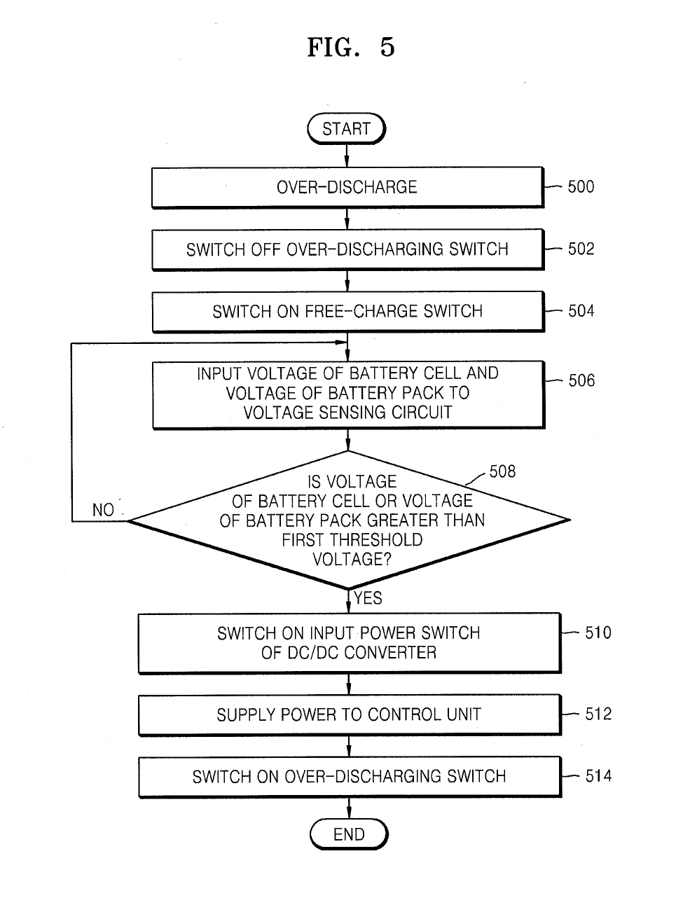

FIG. 5 is a flowchart of a method of controlling a battery pack according to some embodiments.

With reference to FIG. 5, the method includes detecting a condition at which the battery cell is in an over-discharge state as shown by block 500. When a battery cell is over-discharged, an over-discharging switch is switched off as shown by block 502, whereby discharging of the battery cell is blocked.

After the battery cell returns from the over-discharge state, the method proceeds to block 504 and a pre-charge switch is switched on.

A voltage of the battery cell and a voltage of the battery pack are sensed as shown by block 506. At decision block 508, it is determined whether the voltage of the battery cell or the voltage of the battery pack is greater than a first threshold voltage. If one of the two voltages is greater than the first threshold voltage, the method proceeds to block 510 so that an input power switch of a DC/DC converter is switched on The method proceeds to block 512, and a power of the battery cell is supplied to a control unit through the DC/DC converter. As shown by block 514, an over-discharging switch is switched on.

As a result of the determining process of operation 508, if both the voltage of the battery cell and the voltage of the battery pack are less than the first critical voltage, the method proceeds back to block 506.

In the method of controlling a battery pack according to some embodiments, when the over-discharging of the battery cell is blocked, a pre-charge function is performed and the voltage of the battery cell and the voltage of the battery pack are sensed. As a result, if one of the two voltages is greater than a predetermined voltage, the input power switch of the DC/DC converter is switched on, whereby a power may be stably supplied to the control unit of the battery pack. On the other hand, if the voltage of the battery cell and the voltage of the battery pack are less than a predetermined voltage when the battery cell is discharged, the input power switch is maintained in a switched off state, whereby a leakage of current to the DC/DC converter from the battery cell may be blocked and consumption of power of the battery cell may be reduced or avoided.

As described above, according to the one or more embodiments, when a voltage of a battery pack or a charge voltage is greater than a predetermined voltage when the battery pack returns from an over-discharge state, an input voltage switch of a DC/DC converter is switched on, whereby a power may be stably supplied to a control unit of the battery pack. On the other hand, when the voltage of the battery pack is less than a predetermined voltage during discharging, a leakage of current to the DC/DC converter from a battery cell may be reduced or avoided and thus consumption of power of the battery cell may be reduced or avoided.

One or more embodiments described above include a battery pack, and a method of controlling the battery pack. The method includes determining if a voltage of the battery pack or a charge voltage is greater than a predetermined voltage when a battery cell returns from an over-discharge state, if the voltage is greater than a predetermined voltage, an input power switch of a direct current (DC/DC) converter is switched on, whereby a power may be stably supplied to a control unit of the battery pack. On the other hand, if the voltage of the battery pack is less than a predetermined voltage during discharging, the input power switch is maintained in a switched-off state, whereby a leakage of current to the DC/DC converter from the battery cell may be prevented and consumption of power of the battery cell may be reduced or avoided.

According to one or more embodiments, a battery pack includes at least one battery cell. The battery pack includes: an over-discharging switch connected between the at least one battery cell and a terminal of the battery pack, a control unit that controls the over-discharging switch, a direct current (DC)/DC converter that supplies a power of the battery cell to the control unit, a voltage sensing unit that senses a terminal voltage of the battery pack, and an input power switch that switches an input power of the DC/DC converter according to the sensed voltage.

According to some embodiments, if the sensed voltage is less than a first critical value, the input power switch is switched off. When the input power switch is switched off, the over-discharging switch may also be switched off

According to some embodiments, the battery pack may further include a pre-charge switch connected in parallel to the over-discharging switch and a pre-charge resistor connected in series to the pre-charge switch. The voltage sensing unit may include at least one of a first sensing unit that senses a voltage of the battery cell and a second sensing unit that senses a terminal voltage of the battery pack when the over-discharging switch is switched on and the pre-charge switch is switched on. The input power switch switches an input voltage of the DC/DC converter according to a voltage of the battery cell or a terminal voltage of the battery pack.

According to some embodiments, if the voltage of the battery cell or the terminal voltage of the battery pack is greater than a first critical value, the input power switch is switched on, and, on the other hand, if the voltage of the battery cell or the terminal voltage of the battery pack is less than the first critical value, the input power switch is switched off

According to some embodiments, the control unit switches off the pre-charge switch and switches on the over-discharging switch. The first sensing unit and the second sensing unit each include an OR gate comprising a diode.

According to one or more embodiments, a battery pack includes at least one battery cell, an over-discharging switch that blocks over-discharging of the battery cell, a control unit that controls the over-discharging switch, a DC/DC converter that supplies a power of the battery cell to the control unit; a first voltage sensing unit that senses a charge voltage of the battery cell, and an input power switch that switches an input power of the DC/DC converter according to the charge voltage.

According to some embodiments, the battery pack may further include a pre-charge switch and a pre-charge resistor that are connected in parallel to the over-discharging switch; and a second voltage sensing unit that senses a voltage of the battery cell when the over-discharging switch is switched off and the pre-charge switch is switched on, wherein the input power switch is switched on if a voltage of the battery cell or the charge voltage is greater than a first critical value.

According to one or more embodiments, a method of controlling a battery pack including at least one battery cell is disclosed. The method includes switching off an over-discharging switch, sensing a terminal voltage of the battery pack, switching on an input power switch of a DC/DC converter if the terminal voltage is greater than a first critical value, and supplying a power to the control unit through the DC/DC converter.

According to some embodiments, the method further includes switching off the input power switch, if the terminal voltage is less than the first critical value, switching off the over-discharging switch and then switching on a pre-charge switch, and sensing a voltage of the battery cell.

According to some embodiments, if the voltage of the battery cell or the terminal voltage is greater than the first threshold value, an input power switch of the DC/DC converter is switched on, and, on the other hand, if the voltage of the battery cell and the terminal voltage are less than the first threshold value, the input power switch of the DC/DC converter is switched off. The method may further include switching on the over-discharging switch.

The battery pack described herein may include a processor, a memory for storing and executing program data, a permanent storage unit such as a disk drive, a communication port for handling communications with external devices, and a user interface such as a touch panel, keys, and buttons. The methods may be implemented as software modules or algorithms, and may be stored as program instructions or computer-readable codes executable on the processor on a computer-readable recording medium. Here, examples of the computer-readable recording medium include a magnetic storage medium (e.g., a read-only memory (ROM), a random-access memory (RAM), a floppy disk, or a hard disk), and optical reading medium (e.g., a compact disk (CD)-ROM or a digital versatile disk (DVD)). The computer-readable recording medium may be distributed over network coupled computer systems so that the computer-readable code may be stored and executed in a distributed fashion. The computer-readable recording medium may be read by the computer, stored in the memory, and executed by the processor.

For the purposes of promoting an understanding of the principles of the invention, reference has been made to some embodiments illustrated in the drawings, and specific language has been used to describe these embodiments. However, no limitation of the scope of the invention is intended by this specific language, and the invention should be construed to encompass all embodiments that are evident to one of ordinary skill in the art based on the described embodiments.

Embodiments may be described in terms of functional blocks and various processing steps. Such functional blocks may be realized by any number of hardware and/or software components configured to perform specific functions. For example, some embodiments may employ various IC components, e.g., memory elements, processing elements, logic elements, and look-up tables, and the like, which may carry out a variety of functions under the control of one or more microprocessors or other control devices. Similarly, where the elements described are implemented using software programming or software elements, the embodiments may be implemented with any programming or scripting language, such as C, C++, Java, or assembler, with various algorithms being implemented with any combination of data structures, objects, processes, routines, or other programming elements. Functional aspects may be implemented in algorithms that execute on one or more processors. Furthermore, the embodiments described above may employ any number of conventional techniques for electronics configuration, signal processing and/or control, data processing, and the like. The terms “mechanism”, “element”, “means”, and “configuration” are broadly used, and are not limited to mechanical and physical embodiments, but can include software routines in connection with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections, may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the present invention.

It should be understood that the embodiments described herein should be considered in a descriptive sense only and not for purposes of limitation. Descriptions of features or aspects within each embodiment should typically be considered as available for other similar features or aspects in other embodiments.

What is claimed is:

1. A battery pack comprising:
at least one battery cell;
an over-discharging switch connected between the at least one battery cell and a terminal of the battery pack;
a control unit configured to control the over-discharging switch;
a direct current (DC/DC) converter configured to supply power received from the battery cell to the control unit;
a voltage sensing unit configured to sense a voltage of the battery pack; and
an input power switch configured to switch the power input to the DC/DC converter based on the sensed voltage.

2. The battery pack of claim 1, wherein if the sensed voltage is less than a first threshold value, the input power switch is switched off

3. The battery pack of claim 2, wherein when the input power switch is switched off, the over-discharging switch is also switched off

4. The battery pack of claim 1, further comprising a pre-charge switch connected in parallel to the over-discharging switch and a pre-charge resistor connected in series to the pre-charge switch,
wherein the voltage sensing unit comprises at least one of a first sensing unit configured to sense a voltage of the battery cell and a second sensing unit configured to sense a terminal voltage of the battery pack when the over-discharging switch is switched on and the pre-charge switch is switched on,
wherein the input power switch is configured to switch an input voltage of the DC/DC converter according to a voltage of the battery cell or a terminal voltage of the battery pack.

5. The battery pack of claim 4, wherein if at least one of the voltage of the battery cell or the terminal voltage of the battery pack is greater than a first threshold value, the input power switch is switched on; and
if both of the voltage of the battery cell and the terminal voltage of the battery pack are less than the first threshold value, the input power switch is switched off

6. The battery pack of claim 5, wherein the control unit is configured to switch off the pre-charge switch and switch on the over-discharging switch.

7. The battery pack of claim 4, wherein the first sensing unit and the second sensing unit each comprise a logical OR circuit comprising a diode.

8. The battery pack of claim 1, wherein the voltage sensing unit comprises a voltage divider comprises a first resistor and a second resistor, wherein an output of the voltage sensing unit is proportional to voltage of a terminal voltage of the battery pack and is based on a resistance of the first resistor and the second resistor.

9. A battery pack comprising:
at least one battery cell;
an over-discharging switch configured to block over-discharging of the battery cell;
a control unit configured to control the over-discharging switch;
a DC/DC converter configured to supply power from the battery cell to the control unit;
a first voltage sensing unit configured to sense a voltage of the battery pack; and
an input power switch configured to switch the power input to the DC/DC converter according to the sensed voltage.

10. The battery pack of claim 9, further comprising:
a pre-charge circuit comprising a pre-charge switch and a pre-charge resistor that are connected in series, the pre-charge circuit being connected in parallel to the over-discharging switch; and
a second voltage sensing unit configured to sense a voltage of the battery cell when the over-discharging switch is switched off and the pre-charge switch is switched on, wherein the first voltage sensing unit is configured to sense a terminal voltage of the battery pack for charging the battery cell, and wherein the input power switch is switched on if a voltage of the battery cell or the terminal voltage is greater than a first threshold value.

11. The battery pack of claim 10, wherein the first sensing unit and the second sensing unit each comprise a logic OR circuit comprising a diode.

12. The battery pack of claim 9, wherein if the sensed voltage is less than a first threshold value, the input power switch is switched off

13. The battery pack of claim 12, wherein when the input power switch is switched off, the over-discharging switch is also switched off

14. The battery pack of claim 9, wherein the voltage sensing unit comprises a voltage divider comprises a first resistor and a second resistor, wherein an output of the voltage sensing unit is proportional to voltage of the terminal voltage of the battery pack and is based on a resistance of the first resistor and the second resistor.

15. A method of controlling a battery pack comprising at least one battery cell, the method comprising:
switching off an over-discharging switch;
sensing a voltage of the battery pack;
switching on an input power switch of a DC/DC converter if the voltage is greater than a first threshold value; and
supplying power to the control unit through the DC/DC converter.

16. The method of claim 15, further comprising, if the sensed voltage is less than the first critical value, switching off the input power switch.

17. The method of claim 15, further comprising: switching off the over-discharging switch and then switching on a pre-charge switch; and sensing a voltage of the battery cell.

18. The method of claim 17, wherein the sensed voltage comprises a terminal voltage, and wherein if the voltage of the battery cell or the terminal voltage is greater than the first threshold value, an input power switch of the DC/DC converter is switched on; and if the voltage of the battery cell and the terminal voltage are less than the first threshold value, the input power switch of the DC/DC converter is switched off

19. The method of claim 16, further comprising switching on the over-discharging switch.

20. The method of claim 15, wherein the sensed voltage is one a terminal voltage and a battery cell voltage.
